(19) United States
(12) Patent Application Publication
(10) Pub. No.: US 2026/0005582 A1
(43) Pub. Date: Jan. 1, 2026

(54) COOLING ASSEMBLY FOR ELECTRIC MACHINE

(71) Applicants: GE Aerospace Poland Sp. z o.o., Warsaw (PL); General Electric Deutschland Holding GmbH, Frankfurt (DE)

(72) Inventors: Adam Tomasz Pazinski, Warsaw (PL); Israel Luna Acevedo, Munich (DE); Rammohan Rao Kalluri, Munich (DE); Justyna Ewa Gluchowska, Warsaw (PL); Thanasekaran Gopal, Ingolstadt (DE); Mohamed Osama, Garching (DE)

(21) Appl. No.: 19/206,124

(22) Filed: May 13, 2025

(30) Foreign Application Priority Data
Jun. 26, 2024 (PL) P.448974

(51) Int. Cl. H02K 9/197; H02K 1/16

(52) U.S. Cl. CPC H02K 9/197; H02K 1/16; H02K 2209/00

(57) ABSTRACT

An electric machine includes a stator assembly including a stator core defining at least one stator slot, a winding extending through the at least one stator slot, and a cooling assembly disposed around the stator. The cooling assembly includes a casing, a coolant supply in fluid communication with the casing, and a baffle defining one or more apertures, the baffle being disposed between the casing and the coolant supply and arranged to direct a liquid coolant from the coolant supply to the winding.

### PRIORITY INFORMATION

The present application claims priority to Polish Patent Application Serial Number P.448974 filed on Jun. 26, 2024.

### FIELD

The present disclosure relates to electric machines, more particularly to cooling assemblies for electric machines.

### BACKGROUND

Typical aircraft propulsion systems include one or more gas turbine engines. For certain propulsion systems, the gas turbine engines generally include a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Incorporating an electrical machine (e.g., an electrical generator) into a propulsion engine to generate electrical power from mechanical energy generated by the propulsion engine may enhance the capabilities of aircraft. For example, the electrical power generated by the electrical machine may be used to operate an accessory propulsor (e.g., an electric fan, motor, or the like) to supplement thrust provided via the turbine engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional schematic view of a gas turbine engine.

FIG. 2 is a perspective view of an electric machine of the gas turbine engine of FIG. 1.

FIG. 3 is a cross-sectional schematic view of a portion of the electric machine along the line 3-3.

FIG. 4 is another cross-sectional schematic view of a portion of the electric machine.

FIG. 5 is another cross-sectional schematic view of a portion of the electric machine.

FIG. 6 is another cross-sectional schematic view of a portion of the electric machine.

FIG. 7 is another cross-sectional schematic view of a portion of the electric machine.

FIG. 8 is another cross-sectional schematic view of a portion of the electric machine.

FIG. 9 is a view of channels of a stator core of the electric machine along the line 9-9.

FIG. 10 is a block diagram of a method for cooling the electric machine.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The present disclosure is generally related to cooling electric machines in gas turbine engines. During operation, electric machines (such as electric motors and electric generators) generate heat and may be exposed to heat. The heat may interfere with operation of the electric machine, such as increasing an electrical resistance of windings that leads to a decreased magnetic field generated by the windings. Thermal management to dissipate heat leads to improved efficiency and lifespan of the electric machines.

Liquid coolants, such as oils, can provide heat transfer by conduction and convection, and providing a liquid coolant that contacts the windings in the stator dissipates heat from the windings directly. Flooding the stator with the liquid coolant and flowing the liquid coolant across the windings increases heat transfer from the windings, improving efficiency of the electric machine. By sealing the stator core to direct the coolant through slots of the stator core, the total amount of coolant may be reduced while maintaining heat transfer sufficient to cool the windings. Further, such a configuration may allow for liquid cooling without requiring a dedicated seal plate positioned in a rotor gap between a rotor and the stator of the electric machine, which increases a width of the rotor gap and can negatively affect torque and power density of the electric machine.

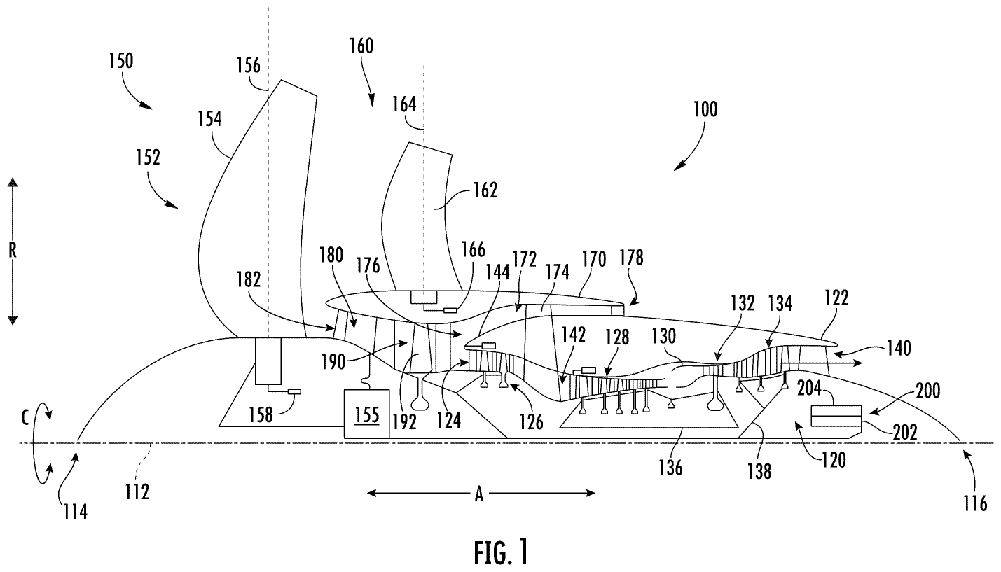

Referring now to FIG. 1, a schematic cross-sectional view of a gas turbine engine 100 according to one example embodiment of the present disclosure is shown. Particularly, FIG. 1 provides an aviation three-stream turbofan engine herein referred to as “three-stream engine”. The three-stream engine of FIG. 1 can be mounted to an aerial vehicle, such as a fixed-wing aircraft, and can produce thrust for propulsion of the aerial vehicle. The three-stream engine is a “three-stream engine” in that its architecture provides three distinct streams of thrust-producing airflow during operation. It will be appreciated that the gas turbine engine 100 may be any suitable engine for an aeronautical vehicle, such as a turbroprop engine, a turbofan engine, a ducted engine, or an unducted engine.

For reference, the gas turbine engine 100 defines an axial direction A, a radial direction R, and a circumferential direction C. Moreover, the gas turbine engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The gas turbine engine 100 extends between a forward end 114 and an aft end 116, e.g., along the axial direction A.

The gas turbine engine 100 includes a turbomachine 120 and a fan section 150 positioned upstream thereof. Generally, the turbomachine 120 includes, in serial flow order, a compressor section, a combustion section, a turbine section, and an exhaust section. Particularly, as shown in FIG. 1, the turbomachine 120 includes an engine core and a core cowl 122 that annularly surrounds the engine core. The engine core and core cowl 122 define an annular core inlet 124. The core cowl 122 further encloses and supports a booster or low pressure (LP) compressor 126 for pressurizing the air that enters the turbomachine 120 through core inlet 124. A high pressure (HP), multi-stage, axial-flow compressor (referred to herein as an HP compressor 128) receives pressurized air from the LP compressor 126 and further increases the pressure of the air. The pressurized air stream flows downstream to a combustor 130 where fuel is injected into the pressurized air stream and ignited to raise the temperature and energy level of the pressurized air.

The high energy combustion products flow from the combustor 130 downstream to a high pressure turbine 132. The high pressure turbine 132 drives the HP compressor 128 through a first shaft or HP shaft 136. In this regard, the high pressure turbine 132 is drivingly coupled with the HP compressor 128. The high energy combustion products then flow to an LP turbine 134. The low pressure turbine 134 drives the LP compressor 126, components of the fan section 150, and an electric machine 200 through a second shaft or LP shaft 138. Specifically, the high energy combustion products drive turbine blades of the low pressure turbine 134. In this regard, the low pressure turbine 134 is drivingly coupled with the LP compressor 126, components of the fan section 150, and the electric machine 200. The LP shaft 138 is coaxial with the HP shaft 136 in this example embodiment. After driving each of the turbines 132, 134, the combustion products exit the turbomachine 120 through a core exhaust nozzle 140 to produce propulsive thrust. Accordingly, the turbomachine 120 defines a core flowpath or core duct 142 that extends between the core inlet 124 and the core exhaust nozzle 140. The core duct 142 is an annular duct positioned generally inward of the core cowl 122 along the radial direction R.

The fan section 150 includes a primary fan 152. For the depicted embodiment of FIG. 1, the primary fan 152 is an open rotor or unducted primary fan 152. However, in other embodiments, the primary fan 152 may be ducted, e.g., by a fan casing or nacelle circumferentially surrounding the primary fan 152. As depicted, the primary fan 152 includes an array of fan blades 154 (only one shown in FIG. 1). The fan blades 154 are rotatable, e.g., about the longitudinal axis 112. As noted above, the primary fan 152 is drivingly coupled with the low pressure turbine 134 via the LP shaft 138. The primary fan 152 can be directly coupled with the LP shaft 138, e.g., in a direct-drive configuration. Optionally, as shown in FIG. 1, the primary fan 152 can be coupled with the LP shaft 138 via a speed reduction gearbox 155, e.g., in an indirect-drive or geared-drive configuration.

Moreover, the fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the primary fan 152 is rotatable about their respective central blades axes 156, e.g., in unison with one another. One or more actuators 158 can be controlled to pitch the fan blades 154 about their respective central blades axes 156. However, in other embodiments, each fan blade 154 may be fixed or unable to be pitched about its central blade axis 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or may be shrouded, e.g., by an annular shroud spaced outward from the tips of the fan guide vanes 162 along the radial direction R. Each fan guide vane 162 defines a central blade axis 164. For this embodiment, each fan guide vane 162 of the fan guide vane array 160 is rotatable about their respective central blades axes 164, e.g., in unison with one another. One or more actuators 166 can be controlled to pitch the fan guide vane 162 about their respective central blades axes 164. However, in other embodiments, each fan guide vane 162 may be fixed or unable to be pitched about its central blade axis 164. The fan guide vanes 162 are mounted to a fan cowl 170.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flowpath or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced struts 174 (only one shown in FIG. 1). The struts 174 may each be aerodynamically contoured to direct air flowing thereby. Other struts in addition to struts 174 may be used to connect and support the fan cowl 170 or core cowl 122.

The gas turbine engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the primary fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a nose of a splitter 144 of the core cowl 122. The inlet duct 180 is wider than the core duct 142 along the radial direction R. The inlet duct 180 is also wider than the fan duct 172 along the radial direction R.

As depicted, the fan section 150 also includes a mid-fan 190. The mid-fan 190 includes an array of mid-fan blades 192 (only one shown in FIG. 1). Each mid-fan blade 192 has a root and a tip and a span defined therebetween. The mid-fan blades 192 are rotatable, e.g., about the longitudinal axis 112. The mid-fan 190 is drivingly coupled with the low pressure turbine 134 via the LP shaft 138. The mid-fan blades 192 can be arranged in equal circumferential spacing around the longitudinal axis 112. The mid-fan blades 192 are annularly surrounded or ducted by the fan cowl 170. In this regard, the mid-fan 190 is positioned inward of the fan cowl 170 along the radial direction R. Moreover, for this example embodiment, the mid-fan 190 is positioned within the inlet duct 180 upstream of both the core duct 142 and the fan duct 172.

Accordingly, air flowing through the inlet duct 180 flows across the mid-fan blades 192 and is accelerated downstream thereof, particularly at the tips of the mid-fan blades 192. At least a portion of the air accelerated by the mid-fan blades 192 flows into the fan duct 172 and is ultimately exhausted through the fan exhaust nozzle 178 to produce propulsive thrust. Also, at least a portion of the air accelerated by the mid-fan blades 192 flows into the core duct 142 and is ultimately exhausted through the core exhaust nozzle 140 to produce propulsive thrust. Generally, the mid-fan 190 is a compression device positioned downstream of the engine inlet 182. The mid-fan 190 is operable to accelerate air into the fan duct 172 or secondary bypass passage.

It will be appreciated, however, that the exemplary gas turbine engine 100 is provided by way of example only. In other exemplary embodiments, the gas turbine engine 100 may have any other configuration. For example, in other exemplary embodiments, the turbomachine 120 may have any other number and arrangement of shafts, spools, compressors, turbines, etc. Further, in other exemplary embodiments, the gas turbine engine 100 may alternatively be configured as a ducted turbofan engine (including an outer nacelle surrounding the primary fan 152 and a portion of the turbomachine 120); as a direct drive gas turbine engine (may not include a reduction gearbox, such as the speed reduction gearbox 155); as a fixed pitch gas turbine engine (may not include a variable pitch fan, such as the primary fan 152); as a two-stream gas turbine engine (may not include the fan duct 172); etc.

Further, for the depicted embodiment of FIG. 1, the gas turbine engine 100 includes an electric machine 200 operably coupled with a rotating component thereof. In this regard, the gas turbine engine 100 is an aeronautical hybrid-electric propulsion machine. Particularly, as shown in FIG. 1, the gas turbine engine 100 includes the electric machine 200 operatively coupled with the LP shaft 138. The electric machine 200 includes a stator assembly 202 and a rotor assembly 204 rotatable within the stator assembly 202. The electric machine 200 can be directly mechanically connected to the LP shaft 138, as is shown, or alternatively the electric machine 200 can be mechanically coupled with the LP shaft 138 indirectly, e.g., by way of a gearbox. Further, although the electric machine 200 is operatively coupled with the LP shaft 138 at an aft end of the LP shaft 138, the electric machine 200 can be coupled with the LP shaft 138 at any suitable location or can be coupled to other rotating components of the gas turbine engine 100, such as the HP shaft 136.

In some embodiments, the electric machine 200 can be an electric motor operable to drive or motor the LP shaft 138, e.g., during an engine burst. In other embodiments, the electric machine 200 can be an electric generator operable to convert mechanical energy into electrical energy. In this way, electrical power generated by the electric machine 200 can be directed to various engine and/or aircraft systems. In some embodiments, the electric machine 200 can be a motor/generator with dual functionality.

It will be appreciated that, in addition to the gas turbine engine 100 described above, the gas turbine engine may have any other suitable configuration. Such configurations may include ducted, direct drive, fixed pitch, or turboprop, among others.

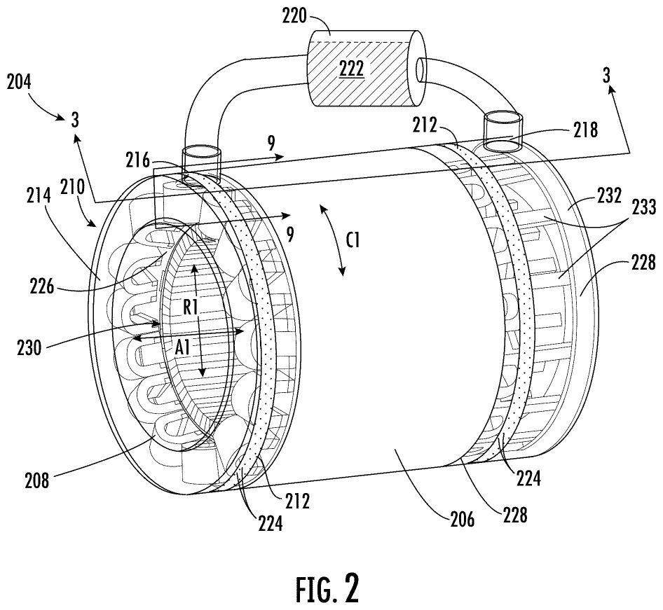

Now referring to FIG. 2, a perspective schematic view of the stator assembly 202 of the electric machine 200 is shown. In particular, the stator assembly 202 is shown to illustrate each of the components that will be explained further in detail below. It will be appreciated that, while the rotor assembly 204 is not shown in FIG. 2, the stator assembly 202 is configured to receive the rotor assembly 204 to form the electric machine 200.

The stator assembly 202 of the electric machine 200 includes a stator core 206 defining an axial direction A1, a radial direction R1, and a circumferential direction C1, a plurality of windings 208, and a cooling assembly 210. The cooling assembly 210 includes a baffle 212, a casing 214 including an inlet 216 and an outlet 218, and a coolant supply 220 including a coolant 222. The stator core 206 includes a first end 226 and a second end 228 and defines a plurality of stator slots 230 extending in the axial direction A1 from the first end 226 to the second end 228. The cooling assembly 210 provides the coolant 222 to the windings 208 disposed in the stator slots 230 the stator core 206, flooding the stator assembly 202 with the coolant 222 to cool the electric machine 200.

As stated above, the stator assembly 202 includes the stator core 206. It will be appreciated that the directions R1, A1, C1 of the stator core 206 are locally defined with respect to the stator core 206. However, in the embodiment shown, the axial direction A1 is arranged parallel to the axial direction A of the gas turbine engine 100. The stator core 206 houses other components of the stator assembly 202, including the plurality of windings 208 and the cooling assembly 210. The stator assembly 202 defines an axial cavity in which the rotor assembly 204 (not shown) rotates. When the electric machine 200 operates as a generator, the rotating rotor assembly 204 generates an electric field that induces current flow through the windings 208. When the electric machine 200 operates as a motor, the windings 208 and the stator assembly 202 generate an electric field that induces rotational motion of the rotor assembly 204.

The baffle 212 of the cooling assembly 210 is disposed between the casing 214 and the coolant supply 220 to provide the coolant 222 to the windings 208. Specifically, the baffle 212 defines one or more apertures 224, and the coolant supply 220 forces the coolant 222 through the one or more apertures 224 to form streams of the coolant 222. The streams of the coolant 222 impinge the windings 208, cooling an interior portion of the windings 208. The cooling assembly 210 thus defines a coolant flowpath for the coolant 222 from the coolant supply 220 through the one or more apertures 224 of the baffle 212 to the plurality of windings 208.

The casing 214 is disposed at the first end 226 over the baffle 212 and extends to the second end 228. The casing 214 forms a fluidtight chamber that encapsulates the plurality of windings 208 within the plurality of stator slots 230. The casing 214 thus inhibits leaking of the coolant 222 from the electric machine 200. Additional seals (not shown) may be disposed around the first end 226 and the second end 228 and engaging the casing 214, forming the fluidtight chamber.

The coolant supply 220 is fluidly connected to the inlet 216 and the outlet 218 of the casing 214. The coolant supply 220 provides coolant 222 to the inlet 216, and the coolant 222 flows through the fluidtight chamber along the plurality of windings 208 from the first end 226 of the stator core 206 to the second end 228 of the stator core 206. The coolant 222 then flows to the outlet 218 and back to the coolant supply 220. While one inlet 216 is shown in the exemplary embodiment of FIG. 2, it will be appreciated that the casing 214 may include two or more ports that communicate the coolant 222 from the coolant supply 220.

The electric machine 200 includes a ring 232 that connects terminals 233 of the windings 208. The ring 232, sometimes referred to as a “phase end ring,” electrically connects the windings 208 to allow electric current between the windings 208. As described above the electric current through the windings 208 and the ring 232 provide power to components when the electric machine 200 is a generator and provide a magnetic field to rotate the rotor assembly 204 when the electric machine 200 is a motor.

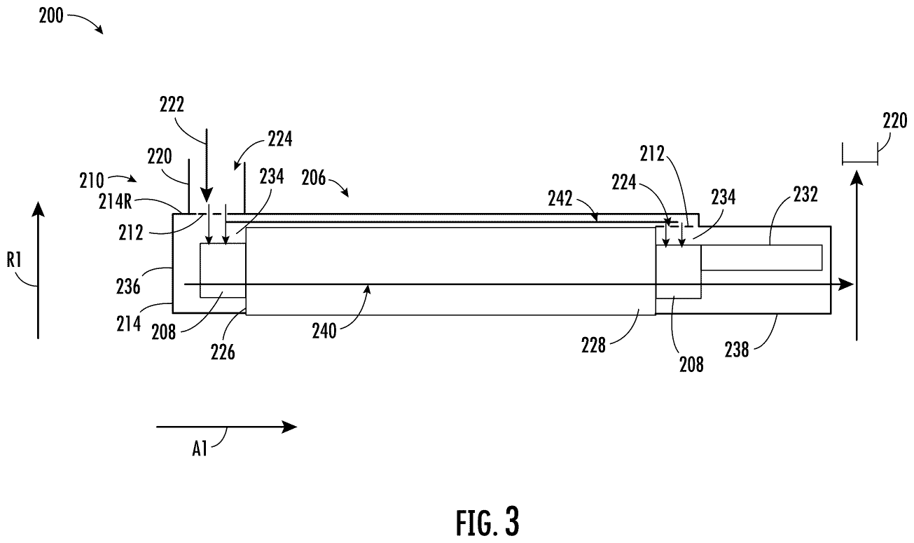

Now referring to FIG. 3, a cross-sectional view of the electric machine 200 along the line 3-3 is shown. Specifically, FIG. 3 shows a stator core 206 and a cooling assembly 210 providing coolant 222 to a winding 208 extending through the stator core 206. As described above, a coolant supply 220 of the cooling assembly 210 forces the coolant through apertures 224 of a baffle 212, which forms streams 234 of the coolant 222 that enter a casing 214. The baffle 212 and the coolant supply 220 are disposed on a radial portion 214R of the casing 214, streaming the coolant 222 in a radial direction R1. Specifically, the casing 214 includes a first end 236 and a second end 238 spaced from the first end 236 in the axial direction A1. The baffle 212 and the coolant supply 220 are disposed at the first end 236 of the casing 214. The coolant supply 220 forces the coolant 222 through the baffle 212, forming streams 234 that impinge the winding 208.

As the coolant supply 220 fills the casing 214 to submerge the windings 208, the coolant 222 flows from the first end 226 of the stator core 206 to the second end 228 of the stator core 206. More specifically, the stator core 206 defines a plurality of channels 240 extending in the axial direction A1 from the first end 226 to the second end 228, and the electric machine 200 defines a plurality of outer channels 242 between the stator core 206 and the casing 214 extending in the axial direction A1 from the first end 226 of the stator core 206 to the second end 228 of the stator core 206. The coolant 222 flows through the plurality of channels 240 and the plurality of outer channels 242, cooling the stator core 206 and the windings 208 therein. Upon reaching the second end 238 of the casing 214, the coolant 222 flows through the baffle 212 to impinge the windings 208 returns to the coolant supply 220.

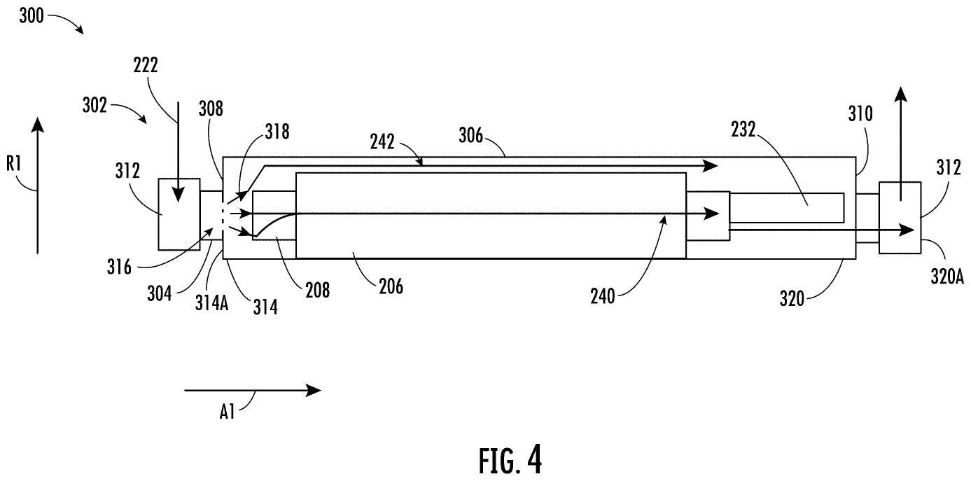

Now referring to FIG. 4, a cross-sectional view of an electric machine 300 is shown. It will be appreciated that parts of the electric machine 300 are similar in name or function to those of the electric machine 200, and similar numbers will be used for those similar parts. The electric machine 300 includes a stator core 206 and a cooling assembly 302 including a baffle 304, a casing 306 including an inlet 308 and an outlet 310, and a coolant supply 312. In FIG. 4, the baffle 304 and the coolant supply 312 are disposed on an axial portion 314A of a first end 314 the casing 306, providing coolant 222 to a winding 208 in the axial direction A1. That is, the coolant 222 flows through apertures 316 of the baffle 304, forming streams 318 that impinge the winding 208 in the axial direction A1. The coolant 222 flows through channels 240 and outer channels 242 of the stator core 206 and the casing 306. Upon flowing through the stator core 206, the coolant 222 flows into the coolant supply 312 disposed on an axial portion 320A of a second end 320 of the casing 306. By positioning the coolant supply 312 and the baffle 304 on the axial portions 314A, 320A of the casing 306, the coolant 222 flows in the axial direction A1 more readily, improving axial flow of the coolant 222 and cooling of the winding 208.

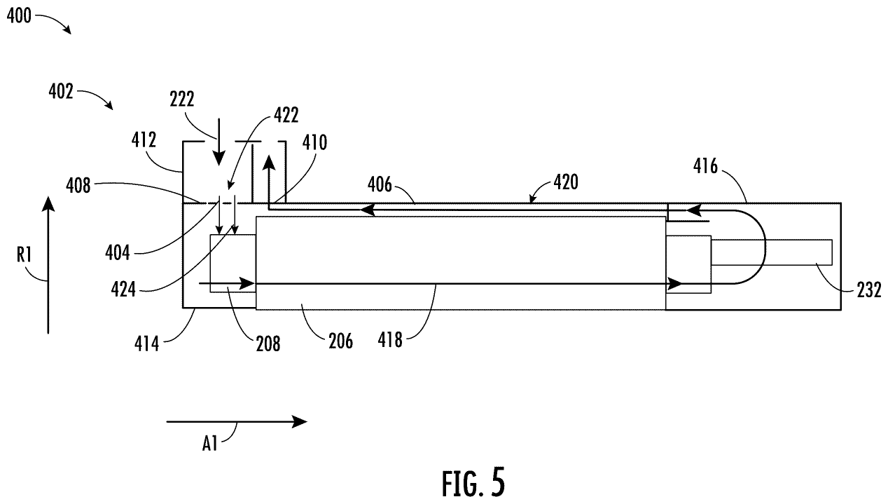

With reference to FIG. 5, a cross-sectional view of an electric machine 400 is shown. The electric machine 400 includes a stator core 206 and a cooling assembly 402 including a baffle 404, a casing 406 including an inlet 408 and an outlet 410, and a coolant supply 412. In FIG. 5, the inlet 408 and the outlet 410 of the casing 406 are both disposed at a first end 414 of the casing 406, such that a coolant 222 flows through the stator core 206 from the first end 414 of the casing 406 to a second end 416 of the casing 406 and then back from the second end 416 of the casing 406 to the first end 414 of the casing 406. In particular, the coolant 222 flows through a plurality of channels 418 defined in the stator core 206 from the first end 414 of the casing 406 to the second end 416 of the casing 406, and then the coolant 222 flows through a plurality of outer channels 420 defined between the casing 406 and the stator core 206 from the second end 416 of the casing 406 to the first end 414 of the casing 406. The coolant supply 412 forces the coolant 222 through apertures 422 the baffle 404, impinging streams 424 of the coolant 222 into the winding 208. By disposing both the inlet 408 and the outlet 410 at the first end 414 of the casing 406, the coolant 222 forms a current that flows back and forth through the stator core 206, improving cooling of the winding 208.

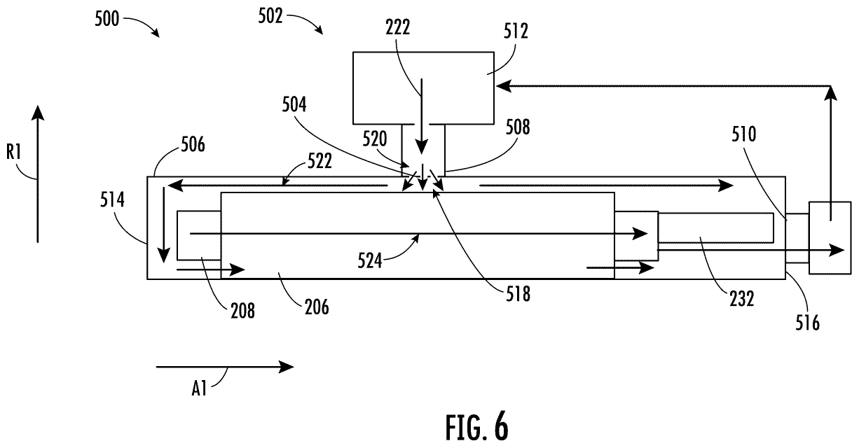

Now referring to FIG. 6, a cross-sectional view of an electric machine 500 is shown. The electric machine 500 includes a stator core 206 and includes a cooling assembly 502 including a baffle 504, a casing 506 including an inlet 508 and an outlet 510, and a coolant supply 512. The casing 506 includes a first end 514 and a second end spaced 516 from the first end 514 in the axial direction A1. In FIG. 6, the coolant supply 512 is disposed at an intermediate location 518 between the first end 514 and the second end 516 in the axial direction A1. The coolant 222 flows through apertures 520 of the baffle 504 into outer channels 522 defined between the casing 506 and the stator core 206 to the first end 514 and the second end 516 of the casing 506. The coolant 222 flows from the first end 514 of the casing 506 through channels 524 defined in the stator core 206 to the second end 516 of the casing 506, cooling the winding 208 therein. Then, at the second end 516 of the casing 506, the coolant 222 returns to the coolant supply 512. By positioning the coolant supply 512 at the intermediate location 518, the coolant 222 forms a current that flows around and through the stator core 206, improving cooling of the windings 208.

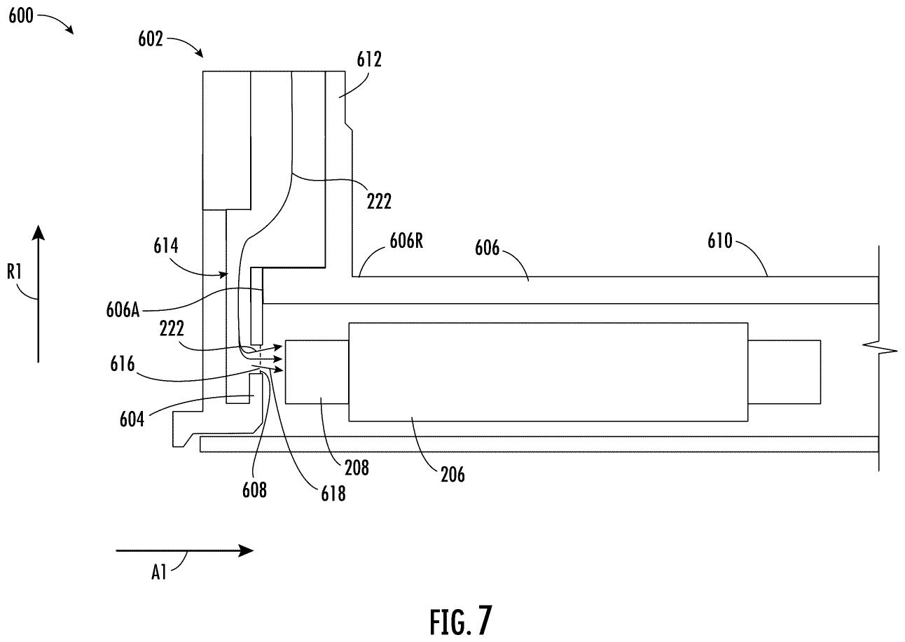

With reference to FIG. 7, a cross-sectional view of an electric machine 600 is shown. The electric machine 600 includes a stator core 206 and a cooling assembly 602 including a baffle 604, a casing 606 including an inlet 608 and an outlet 610, and a coolant supply 612. In FIG. 7, the coolant supply 612 is disposed on a radial portion 606R of the casing 606, and the baffle 604 is disposed on an axial portion 606A of the casing 606. A duct 614 extends in the radial direction R1 from the coolant supply 612 to the baffle 604 to provide coolant 222. The coolant 222 is forced through apertures 616 of the baffle 604, forming stream 618 that impinge the windings 208. By positioning the coolant supply 612 on the radial portion 606R of the casing 606, space constraints in the axial direction A1 are more easily addressed. By positioning the baffle 604 on the axial portion 606A of the casing 606, the streams 618 of the coolant 222 more easily impinge the windings 208.

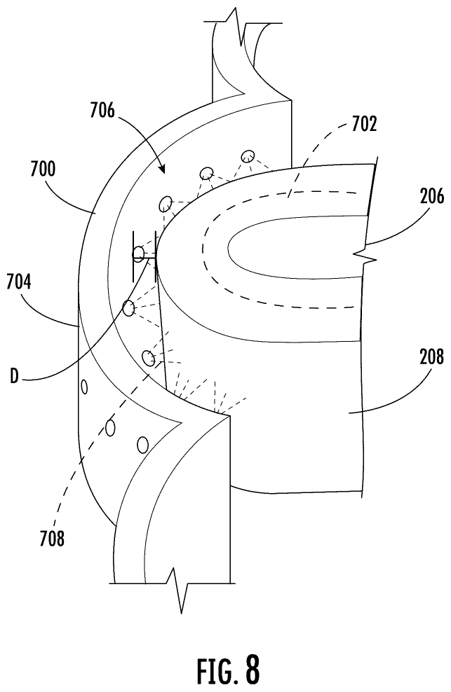

Now referring to FIG. 8, a perspective view of a baffle 700 and one of a plurality of windings 208 are shown. It will be appreciated that the baffle 700 is exemplary and may be incorporated as any of the baffles 212, 304, 404, 504, 604 described above. In general, the winding 208 may have an arcuate shape 702, curving out from and back into a stator core 206. The baffle 700 may include a plurality of arcuate segments 704, each arcuate segment 704 extending along the respective arcuate shape 702 of each of the plurality of windings 208. In particular, apertures 706 of the baffle 700 are arranged such that a distance D between each aperture 706 and the winding 208 is substantially the same. That is, streams 708 of coolant 222 that flow from the apertures 706 to the winding 208 are each substantially a same length, the distance D, such that an amount of the coolant 222 impinging the winding 208 is substantially consistent along the surface area of the winding 208.

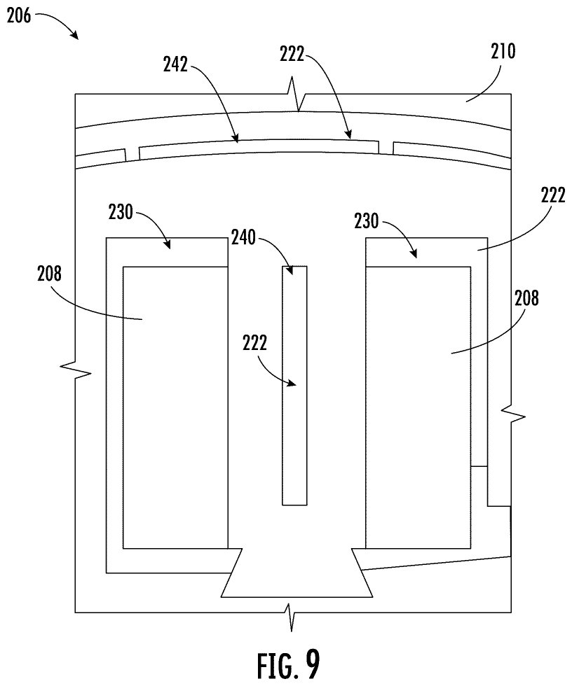

With reference to FIG. 9, a cross-sectional view of a stator core 206 along the line 9-9 of FIG. 2 is shown. As described above with reference to FIG. 2, the stator core 206 includes a plurality of channels 240 through which coolant 222 flows to cool the windings 208. Further, a cooling assembly 210 and the stator core 206 define a plurality of outer channels 242 through which the coolant 222 flows. The stator core 206 defines a plurality of stator slots 230 in which the windings 208 are disposed, and each of the plurality of channels 240 is disposed between two adjacent ones of the plurality of stator slots 230. Specifically, each of the plurality of channels 240 extends in the axial direction from a first end 226 (FIG. 2) of the stator core 206 to a second end 228 (FIG. 2) of the stator core 206 to allow the coolant 222 to flow therethrough. The channels 240 and the outer channels 242 may have any suitable shape, such as a rectangular shape, a square shape, another polygonal shape, an elliptical shape, a circular shape, or combinations thereof.

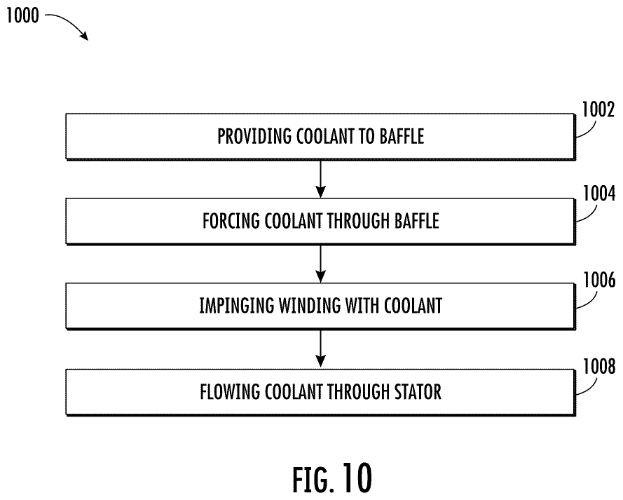

Referring now to FIG. 10, a flow diagram of a method 1000 of operating a gas turbine engine in accordance with an exemplary aspect of the present disclosure is provided. The method 1000 of FIG. 10 may be utilized to operate one or more of the exemplary electric machines described above with reference to FIGS. 2 through 8. Accordingly, it will be appreciated that the method 1000 may generally be utilized to cool a winding of the electric machine.

As is depicted, the method 1000 includes at (1002) providing coolant to a baffle of a cooling assembly of the electric machine. In particular, a coolant supply provides coolant to a casing of the cooling assembly such that the coolant reaches the baffle.

The method 1000 includes at (1004) forcing the coolant through one or more apertures of the baffle to form a stream of the coolant. Because the apertures of the baffle are smaller than the casing through which the coolant flows, a pressure of the coolant increases when flowing through the smaller apertures. In particular, the coolant may be pressurized by a pump or other device that forces the coolant through the apertures.

The method 1000 includes at (1006) impinging the winding with a stream of the coolant. The apertures of the baffle are arranged to form and direct the stream of the coolant to the winding. That is, by forcing the coolant through the apertures, momentum of the coolant increases to guide flow of the coolant into the stream. The increased momentum of the stream may force some of the coolant between individual wires of the winding, impinging the fluid into the winding.

The method 1000 includes at (1008) flowing the coolant through a channel of a stator of the electric machine. As some of the coolant impinges the winding, the remainder of the coolant fills the casing surrounding the winding such that the winding becomes submerged in the coolant. Channels defined in the stator core collect the coolant, allowing the coolant to flow from a first end of the stator core to a second end of the stator core. The coolant flowing through the channels and through the winding cool the stator core and the winding, improving operation of the electric machine.

Further aspects are provided by the subject matter of the following clauses:

An electric machine defining an axial direction, a radial direction, and a circumferential direction, the electric machine including a stator assembly including a stator core defining at least one stator slot a winding extending through the at least one stator slot, and a cooling assembly disposed around the stator assembly, the cooling assembly including a casing, a coolant supply in fluid communication with the casing, and a baffle defining one or more apertures, the baffle being disposed between the casing and the coolant supply and arranged to direct a liquid coolant from the coolant supply to the winding.

The electric machine of any of the preceding clauses, wherein the cooling assembly defines a coolant flowpath for a liquid coolant from the coolant supply through the one or more apertures of the baffle to the winding.

The electric machine of any of the preceding clauses, wherein the stator core defines a plurality of channels and a plurality of stator slots including the at least one stator slot, each of the plurality of channels disposed between two adjacent ones of the plurality of stator slots, each of the plurality of channels extending in the axial direction from a first end of the stator core to a second end of the stator core.

The electric machine of any of the preceding clauses, wherein the stator core and the casing define at least one outer channel extending in the axial direction from the first end of the stator core to the second end of the stator core.

The electric machine of any of the preceding clauses, wherein the casing includes a first end including an inlet and a second end including an outlet, wherein the baffle is disposed at the inlet of the casing, and wherein the coolant supply is in fluid communication to the inlet and the outlet.

The electric machine of any of the preceding clauses, wherein the casing includes a first end and a second end spaced from the first end in the axial direction, wherein the first end includes an inlet and an outlet, wherein the baffle is disposed at the inlet of the casing, and wherein the coolant supply is fluidly connected to the inlet and the outlet.

The electric machine of any of the preceding clauses, wherein the baffle is disposed on a radial portion of the casing.

The electric machine of any of the preceding clauses, wherein the baffle is disposed on an axial portion of the casing.

The electric machine of any of the preceding clauses, wherein the cooling assembly further includes a duct between the coolant supply to the baffle, wherein the coolant supply is disposed on a radial portion of the casing and the duct extends in the radial direction from the coolant supply to the baffle.

The electric machine of any of the preceding clauses, wherein the coolant supply is disposed forward of the baffle in the axial direction.

The electric machine of any of the preceding clauses, wherein the casing includes a first end and a second end spaced from the first end in the axial direction, wherein the coolant supply is disposed at a first end of the casing.

The electric machine of any of the preceding clauses, wherein the casing includes a first end and a second end spaced from the first end in the axial direction, wherein the coolant supply is disposed at an intermediate location between the first end and the second end in the axial direction.

The electric machine of any of the preceding clauses, wherein the winding defines an arcuate shape, wherein the baffle includes an arcuate segment extending along the arcuate shape of the winding.

The electric machine of any of the preceding clauses, wherein the one or more apertures are arranged to impinge a coolant from the coolant supply into the winding.

A method for cooling a winding of an electric machine includes providing a coolant to a baffle disposed adjacent to the winding, forcing the coolant through one or more apertures of the baffle to form a stream of the coolant, and impinging the winding with the stream of the coolant.

The method of any of the preceding clauses, wherein forcing the coolant further includes pressurizing the coolant with a coolant supply.

The method of any of the preceding clauses, wherein the baffle includes an arcuate segment that extends along an arcuate shape of the winding, and wherein forcing the cooling through the one or more apertures of the baffle further includes forcing the coolant through the arcuate segment.

The method of any of the preceding clauses, further including flowing the coolant through a channel of a stator of the electric machine.

The method of any of the preceding clauses, wherein impinging the winding further includes directing the stream of the coolant through the one or more apertures of the baffle to the winding.

The method of any of the preceding clauses, further including filling a casing surrounding the winding with the coolant such that the winding is submerged in the coolant.

A cooling assembly includes a casing, a coolant supply in fluid communication with the casing, and a baffle defining one or more apertures, the baffle being disposed between the casing and the coolant supply.

The cooling assembly of any of the preceding clauses, wherein the cooling assembly defines a coolant flowpath for a liquid coolant from the coolant supply through the plurality of apertures of the baffle.

The cooling assembly of any of the preceding clauses, wherein the casing includes a first end including an inlet and a second end including an outlet, wherein the baffle is disposed at the inlet of the casing, and wherein the coolant supply is fluidly connected to the inlet and the outlet.

The cooling assembly of any of the preceding clauses, wherein the casing includes a first end and a second end, the second end spaced from the first end in the axial direction, wherein the first end includes an inlet and an outlet, wherein the baffle is disposed at the inlet of the casing, and wherein the coolant supply is fluidly connected to the inlet and the outlet.

The cooling assembly of any of the preceding clauses, wherein the baffle is disposed on a radial portion of the casing.

The cooling assembly of any of the previous clauses, wherein the baffle is disposed on an axial portion of the casing.

The cooling assembly of any of the previous clauses, wherein the cooling assembly further includes a duct between the coolant supply to the baffle, wherein the coolant supply is disposed on a radial portion of the casing and the duct extends in the radial direction from the coolant supply to the baffle.

The cooling assembly of any of the previous clauses, wherein the coolant supply is disposed forward of the baffle in the axial direction.

The cooling assembly of any of the previous clauses, wherein the casing includes a first end and a second end spaced from the first end in the axial direction, wherein the coolant supply is disposed at a first end of the casing.

The cooling assembly of any of the previous clauses, wherein the casing includes a first end and a second end spaced from the first end in the axial direction, wherein the coolant supply is disposed at an intermediate location between the first end and the second end in the axial direction.

The cooling assembly of any of the previous clauses, wherein the baffle includes an arcuate segment.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An electric machine defining an axial direction, a radial direction, and a circumferential direction, the electric machine comprising:
a stator assembly including a stator core defining at least one stator slot;
a winding extending through the at least one stator slot; and
a cooling assembly disposed around the stator assembly, the cooling assembly comprising:
a casing;
a coolant supply in fluid communication with the casing; and
a baffle defining one or more apertures, the baffle being disposed between the casing and the coolant supply and arranged to direct a liquid coolant from the coolant supply to the winding.

2. The electric machine of claim 1, wherein the cooling assembly defines a coolant flowpath for a liquid coolant from the coolant supply through the one or more apertures of the baffle to the winding.

3. The electric machine of claim 1, wherein the stator core defines a plurality of channels and a plurality of stator slots including the at least one stator slot, each of the plurality of channels disposed between two adjacent ones of the plurality of stator slots, each of the plurality of channels extending in the axial direction from a first end of the stator core to a second end of the stator core.

4. The electric machine of claim 3, wherein the stator core and the casing define at least one outer channel extending in the axial direction from the first end of the stator core to the second end of the stator core.

5. The electric machine of claim 4, wherein the casing includes a first end including an inlet and a second end including an outlet, wherein the baffle is disposed at the inlet of the casing, and wherein the coolant supply is in fluid communication to the inlet and the outlet.

6. The electric machine of claim 4, wherein the casing includes a first end and a second end spaced from the first end in the axial direction, wherein the first end includes an inlet and an outlet, wherein the baffle is disposed at the inlet of the casing, and wherein the coolant supply is fluidly connected to the inlet and the outlet.

7. The electric machine of claim 1, wherein the baffle is disposed on a radial portion of the casing.

8. The electric machine of claim 1, wherein the baffle is disposed on an axial portion of the casing.

9. The electric machine of claim 8, wherein the cooling assembly further comprises a duct between the coolant supply to the baffle, wherein the coolant supply is disposed on a radial portion of the casing and the duct extends in the radial direction from the coolant supply to the baffle.

10. The electric machine of claim 8, wherein the coolant supply is disposed forward of the baffle in the axial direction.

11. The electric machine of claim 1, wherein the casing includes a first end and a second end spaced from the first end in the axial direction, wherein the coolant supply is disposed at a first end of the casing.

12. The electric machine of claim 1, wherein the casing includes a first end and a second end spaced from the first end in the axial direction, wherein the coolant supply is disposed at an intermediate location between the first end and the second end in the axial direction.

13. The electric machine of claim 1, wherein the winding defines an arcuate shape, wherein the baffle includes an arcuate segment extending along the arcuate shape of the winding.

14. The electric machine of claim 1, wherein the one or more apertures are arranged to impinge a coolant from the coolant supply into the winding.

15. A method for cooling a winding of an electric machine, the method comprising:
providing a coolant to a baffle disposed adjacent to the winding;
forcing the coolant through one or more apertures of the baffle to form a stream of the coolant; and
impinging the winding with the stream of the coolant.

16. The method of claim 15, wherein forcing the coolant further comprises pressurizing the coolant with a coolant supply.

17. The method of claim 15, wherein the baffle includes an arcuate segment that extends along an arcuate shape of the winding, and wherein forcing the cooling through the one or more apertures of the baffle further comprises forcing the coolant through the arcuate segment.

18. The method of claim 15, further comprising flowing the coolant through a channel of a stator of the electric machine.

19. The method of claim 15, wherein impinging the winding further comprises directing the stream of the coolant through the one or more apertures of the baffle to the winding.

20. The method of claim 15, further comprising filling a casing surrounding the winding with the coolant such that the winding is submerged in the coolant.
